(19) United States
(12) Patent Application Publication
(10) Pub. No.: US 2015/0073904 A1
(43) Pub. Date: Mar. 12, 2015

(54) Graphical User Interface for a Search Engine Including User Selectable Advertisement Categories

(71) Applicant: Yang Pan, Singapore (SG)

(72) Inventor: Yang Pan, Singapore (SG)

(21) Appl. No.: 14/019,538

(22) Filed: Sep. 6, 2013

(51) Int. Cl. G06Q 30/02

(52) U.S. Cl. CPC G06Q 30/0256
USPC 705/14.54

(57) ABSTRACT

A graphical user interface of a personal computing device includes a search box and a search button. An advertising selection menu including a plurality of user selectable advertising categories is displayed after a user actuates the search button while the search box is blanket. A content provider receives the user's selection of the advertising categories. Targeted advertisements are rendered to the user by the content provider when contents based upon a subsequent search query are delivered to the user through the personal device.

### CROSS-REFERENCE TO RELATED APPLICATIONS

Not applicable

### BACKGROUND

1. Field of Invention

This invention relates generally to an advertising system. More specifically, the invention describes a system and method for delivering a targeted advertising message to a user of a search engine through the user's proactive interactions using a graphical user interface.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Personal computing devices have gained significant popularity in recent years. Users are using the personal devices such as, for example, iPhone from Apple Inc, Cupertino, Calif., to access the Internet services. Methods for delivering targeted advertisements to users by employing the personal devices have been developed.

Search engines have been widely used by many users of the personal devices to assess contents in the Internet. Search engine advertising involves displaying advertisements on search results pages. The user's personal device displays advertisements along with search results, and users are able to select either an advertisement link or a search result link to cause their devices to retrieve information pages from the World Wide Web. Conventional search engines cause a separate search results page with the search results to be loaded onto the user's device, while some modern search engine interfaces display search results and advertisements as the user enters his or her search query without loading a separate results page. But in either case, both the advertisements and the search results are selected for display based on search queries entered by the users in a search engine page through a web browser, or other interface. The search results are produced by a search engine, and are typically based in part on various search algorithms whose purpose is to select web pages that are relevant to the user's search query. Advertisements, on the other hand, are selected in part based on bids that advertisers make for particular keywords in the user's search query.

It has always been a significant challenge to understand the user's real interests and to deliver advertising messages with improved accuracy. It is desirable that a search engine receives directly a user's inputs about his or her commercial interests. Highly targeted advertisements can then be delivered.

### SUMMARY OF THE INVENTION

It is an object of the present invention to provide an advertisement delivery system for delivering highly targeted advertisements to a user of a personal computing device.

It is another object of the present invention to provide a graphical user interface for receiving a user's direct inputs on one's commercial interests while the user is using a search engine.

An exemplary system comprises a personal computing device connectable to a communication network. A search engine including a first advertising manager and a content provider including a second advertising manager are located in the network. In one embodiment, the search engine and the content provider are different entities. In another embodiment, the search engine and the content provider are the same entity.

In a first embodiment of the graphical user interface, a search box and a search button are displayed on a screen of the personal device. A user actuates the search button before a search query is entered into the search box. Subsequently, an advertising selection menu including a plurality of user selectable advertising categories is displayed. The search engine receives a search query and transmits the search query with the user selected advertising category to a content provider. The advertising manager of the content provider selects an advertising message based on received category. The content provider renders contents matched to the query together with the advertising message through the personal device. The search engine and the content provider may share the advertising revenue based on a predetermined agreement.

The user selectable advertising categories may include sub-categories. The categories and sub-categories may be organized and be rendered in a hierarchical manner

In a second embodiment of the graphical user interface, an advertising selection menu is displayed together with a search box and a search button. The user actuates the advertising selection menu and selects one or more advertising categories. In one implementation, the advertising selection menu displays one advertising category before the user's actuation. The displayed category may be based on a history of the user's selection of the advertising categories using the system.

In a third embodiment of the graphical user interface, an advertising selection menu is displayed after a search query is entered. The user may select one or more advertising categories. In one implementation, displayed advertising categories may be related to the search query. In another implementation, displayed categories may not be related to the search query.

Before the advertising selection menu is displayed, advertising categories to be displayed may be selected by the search engine based upon additionally on a location of the personal device and/or a personal profile of the user.

Advertising messages may be selected by the content provider based upon additionally on a location of the personal device and/or a personal profile of the user.

The content provider may be selected by the search engine based on an on line bidding process.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary system in a first embodiment with a search engine and a content provider as different entities;

FIG. 2 is a schematic diagram illustrating an exemplary system in a second embodiment with a search engine and a content provider as the same entity;

FIG. 3 is a schematic diagram illustrating an exemplary graphical user interface for a search engine in a first embodiment;

FIG. 4 is a schematic diagram illustrating an exemplary graphical user interface for a search engine in a second embodiment;

FIG. 5 is a schematic diagram illustrating an exemplary graphical user interface for a search engine in a third embodiment;

FIG. 6 is an exemplary flowchart illustrating the operation of the user interface according to the first embodiment;

FIG. 7 is an exemplary flowchart illustrating the operation of the user interface according to the second embodiment;

FIG. 8 is an exemplary flowchart illustrating the operation of the user interface according to the third embodiment.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

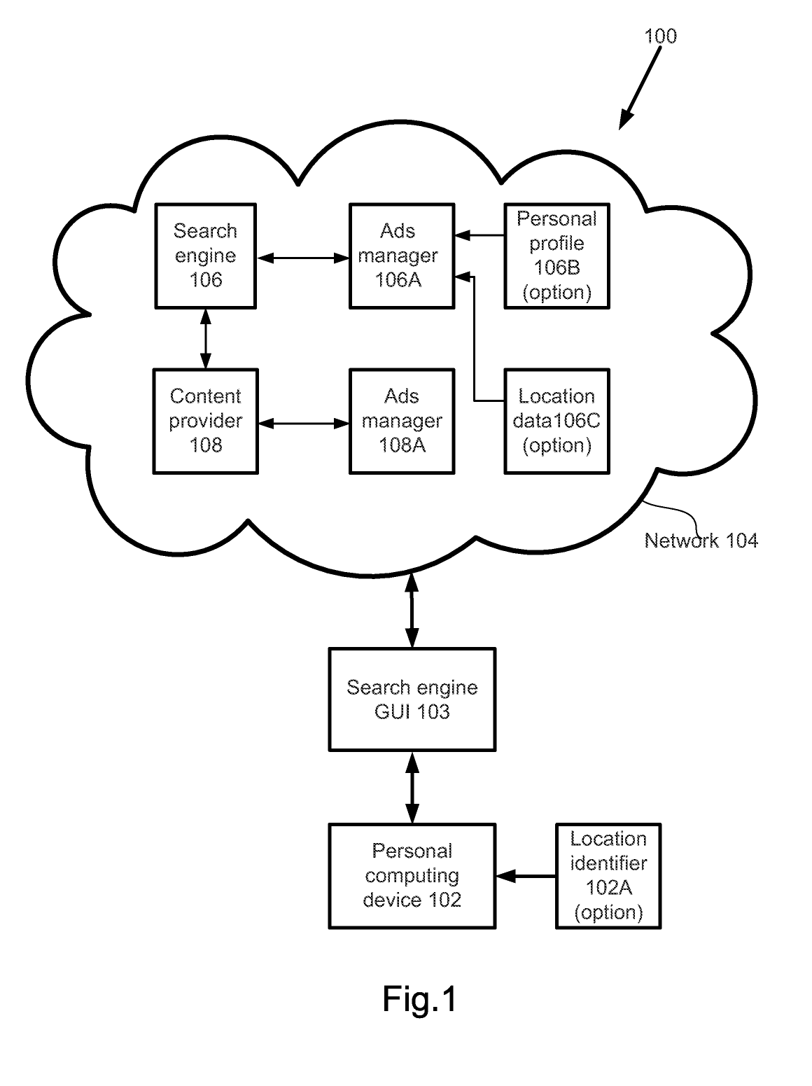

FIG. 1 is a schematic diagram illustrating an exemplary system in the first embodiment. Exemplary system 100 comprises a personal computing device 102 and a communication network 104. Personal device 102 includes but is not limited to a smart phone, a tablet computer, a laptop computer, a desktop computer, a netbook and a media player. Communication network 104 includes but is not limited to the Internet. Personal computing device 102 is connectable to network 104. In an exemplary case, personal device 102 may be connected to network 104 through a wireless communication device. Personal device 102 may also be connected to network 104 through a wired broadband communication device. In the first embodiment, search engine 106 is operated by a search engine company. A user can enter a search query through a search engine graphical user interface (GUI) 103. After receiving the search query, search engine 106 renders typically on a new page a plurality of search results. For example, a link to a website may be displayed on a display screen of personal device 102 as one of the search results. The user may select the link to the website. As a result, contents matched to the query may be rendered by content provider 108 through network 104. It should be noted that the search results may also be displayed in the same page as the search box.

According to the first embodiment, search engine 106 further includes advertising manager 106A pertaining to determining user selectable advertising categories to be rendered to the user through GUI 103. In one implementation, advertising categories may be determined additionally by a personal profile 106B of the user. Personal profile 106B may include personal information related to the user including a history of the user's selection of advertising categories through GUI 103. A user will need to be identified. Methods for identifying a user of a personal device are well known in the art. In another implementation, personal profile 106B may also be located in personal device 102 and be transmitted to search engine 106 and be used by advertising manager 106A.

In another implementation, advertising categories may be determined additionally by location data 106C. Personal device 102 may include a Global Positioning System (GPS) to determine its location. Position identifier 102A in personal device 102 further includes but is not limited to network based techniques utilizing a service provider's network infrastructure to identify the location of the device, handset based technology requiring the installation of client software on the handset to determine the location and WiFi based technique using crowdsourced WiFi data to identify the location. The location data is transmitted to search engine 106 and is stored as location data 106C in advertising manager 106A. Advertising manager 106A may select location-based advertising categories. For example, search engine 106 may detect the user is in a vicinity of a restaurant area at dinner time. Dinning related advertising categories may be sent to personal device 102. Personal profile 106B and location identifier 102A and location data 106C are optional. They are not essential functional blocks of the present inventive concept.

In the first embodiment, content provide 108 further includes an advertising manager 108A pertaining to selecting advertising messages based upon received user selection of the advertising categories. Selected advertising messages are rendered by content provider 108 in accompanying with contents matched to the search query. For example, if the content is a video program, the advertising messages may be rendered at beginning of the video program or in any of selected time slots when the video program is being streamed. The present invention as described in the first embodiment enables the user to have flexibility to select preferred categories of advertisements when viewing an advertising message becomes unavoidable.

In the first embodiment, revenue generated by the advertising may be shared between search engine 106 and content provide 108. In one implementation, sharing of the revenue may be based upon an agreement between search engine 106 and content provider 108. In another implementation, search engine 106 may receive bids from different content providers and award an opportunity to one or multiple selected content providers based upon criteria including but are not limited to pricing. The other criteria may include relevance of the content to the search query.

In yet another implementation, advertisers (not shown in FIG. 1) may also be involved. In an exemplary case, content provider 108 may purchase the opportunity from search engine 106 and may receive advertisements from the advertisers in network 104.

In yet another implementation, content provider 108 may send the content matched to the query to search engine 106. Advertising messages may be added to the contents by search engine 106. Search engine 106 may need to purchase usages of the content from content provider 108 and receive payment from advertisers.

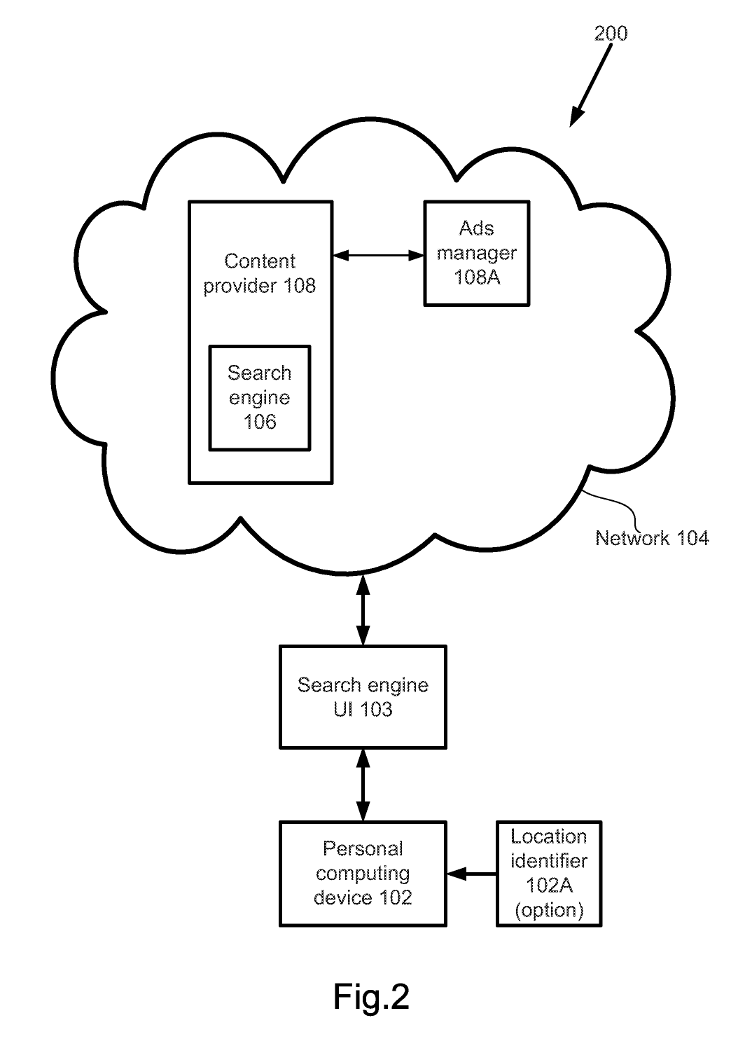

FIG. 2 is a schematic diagram illustrating an exemplary system 200 in a second embodiment. Content provider 108 includes a search engine 106. Many of today's content providers such as, for example, Wikipedia include a local search box in its website. A user may enter a search query and receive contents from the content provider. In the second embodiment, content provider 108 renders the content matched to the search query to the user through GUI 103. Advertising categories are selected by advertising manager 108A before advertising selection menu is displayed. Advertising messages are then selected based upon selected categories by the same advertising manager 108A. Advertising categories and messages may be determined based additionally on the user's profile and/or location of personal device 102.

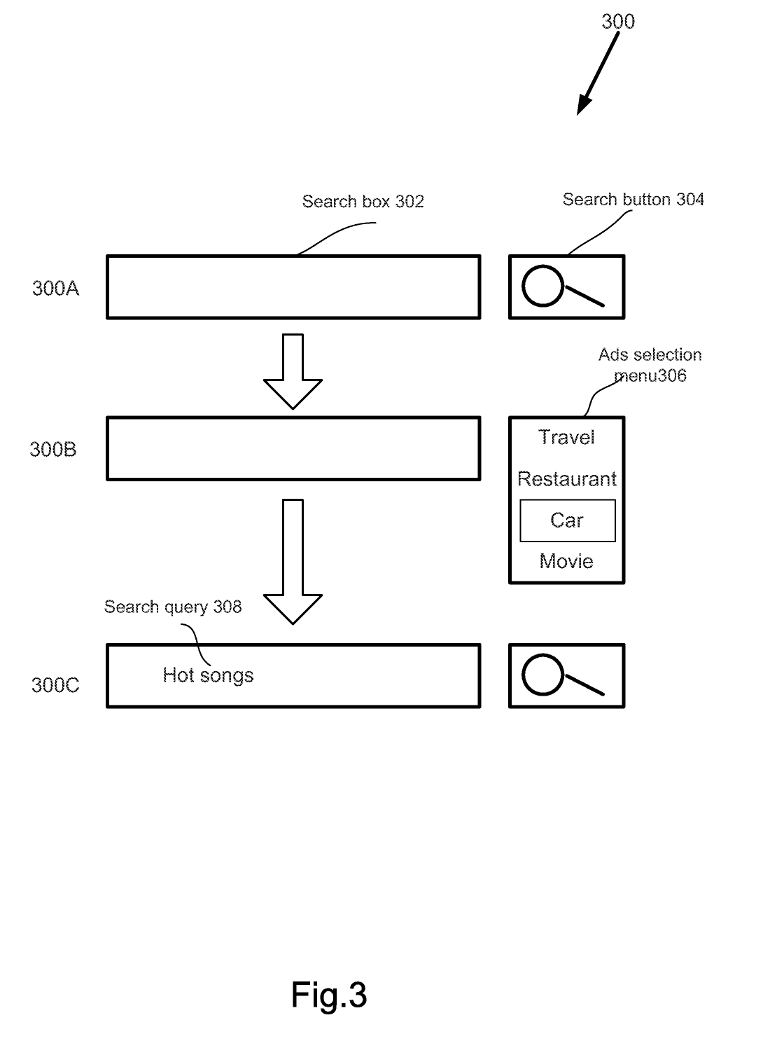

GUI 103 may be implemented according to three different embodiments. FIG. 3 is a schematic diagram illustrating an exemplary user interface 300 pertaining to receiving a user's search query, to displaying user selectable advertising categories and to receiving the user's selection. As shown in 300A, search box 302 is displayed on a screen of personal device 102. Search button 304 is displayed in an adjacent position to search box 302. In a conventional implementation of a user interface for a search engine, a user may enter a search query and actuate the search button 304 to receive search results in a new page. In modern search engines, search results may also be displayed in the same page as the search box.

As shown in FIG. 3, search button 304 is displayed in an exemplary manner on right side of search box 302. Search button 304 may also be displayed in left side, bottom side and top side of search box 302.

According to the first embodiment of the graphical user interface, the user actuates search button 304 before any search query is entered into search box 302. In response to the user's actuation of search button 304, advertising selection menu 306 including a plurality of user selectable advertising categories is displayed as shown in 300B. In one implementation as shown in FIG. 3, advertising selection menu 306 replaces search button 304 with a larger display window. The implementation is exemplary. Advertising selection menu 306 may also be displayed as a new window in any position on the screen. Search button 304 may be removed temporarily from the screen. In another implementation, search button 304 may be left on the screen while advertising selection menu 306 is displayed. Search button 304 may also be covered with a shadowed area.

The user selectable advertising categories may include any category of advertisements. Advertising selection menu 306 as shown in 300B is for illustrative purpose only. More or less numbers of categories may be displayed. Different categories may be displayed. Categories may be displayed from top to bottom. The categories may also be displayed from left to right. The categories may be displayed in a two dimensional manner. The categories may also be displayed one by one sequentially. The categories may even be displayed in a three dimensional manner The categories may be displayed in accompanying with a voice signal. The categories may be displayed with an animation.

The user may select one or more categories through a user input device of personal computing device as well known in the art. The user input devices include but are not limited to a touch-sensitive screen, a keyboard, a mouse, a touchpad and a voice input unit comprising a voice recognition unit. The user's selection is sent to search engine 106 and is then sent to anyone of the content providers that provides contents matched to the query.

In response to the user's selection of the advertising category, advertising selection menu 306 is removed from the screen and search button 304 is redisplayed on the screen according to one implementation as shown in 300C. The user enters a search query 308 into search box 302 and actuates search button 304 subsequently.

In response to the search query, search engine 106 displays a plurality of search results. The user may select one of the results. Upon the user's selection, content provider 108 renders contents matched to the query together with advertising messages selected by advertising manager 108A based on the selected advertising categories.

Search engine 106 and content provider 108 may be different entities. Search engine and content provider may the same entity.

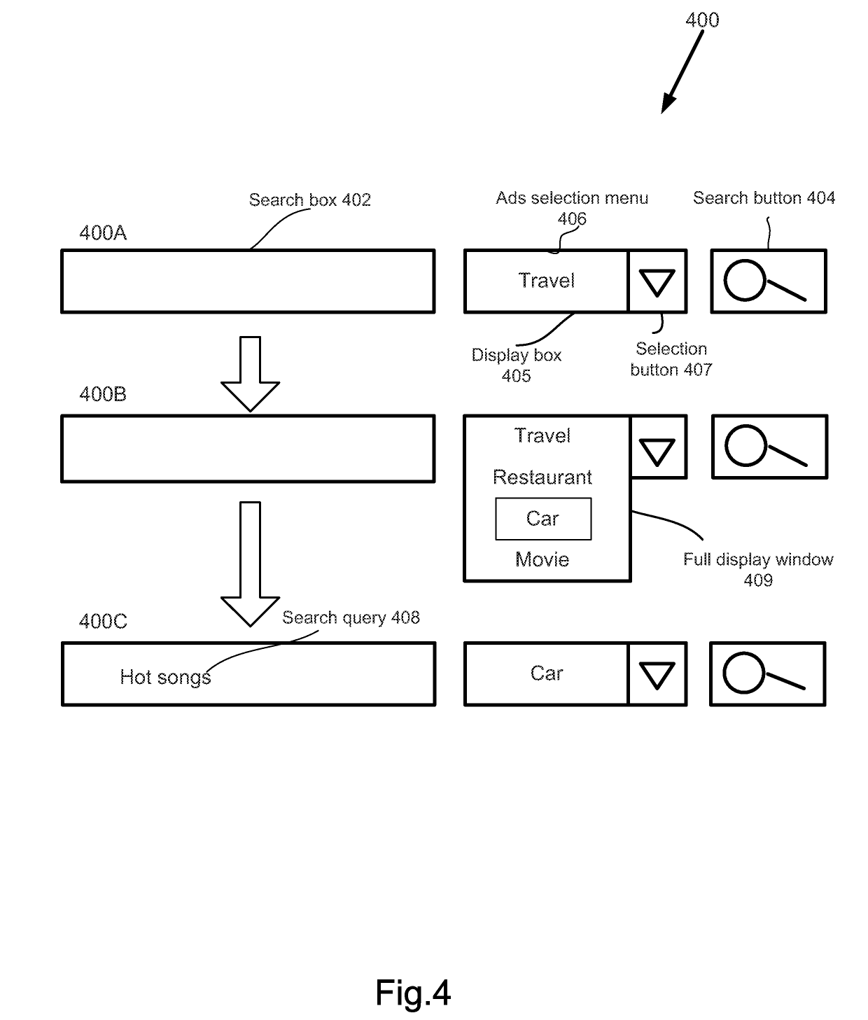

FIG. 4 is a schematic diagram illustrating an exemplary graphical user interface 400 in a second embodiment. According to the second embodiment of the user interface, search box 402, search button 404 and advertising selection menu 406 are displayed concurrently as shown in 400A. Advertising selection menu 406 further includes a display box 405 and a selection button 407. Display box 405 may display one advertising category initially. In one implementation, the displayed category is the most favorable category of the user assessed by search engine 106 based upon personal file 106B.

Upon the user's actuation of selection button 407, a plurality of advertising categories is listed as shown in 400B. In 400B, full display window 409 is illustrated in an exemplary manner as an extension of display box 405. Full display window 409 may be displayed in any selected position on the screen. Similarly, the categories may be displayed in many different manners as discussed in graphical user interface 300.

Upon the user's selection of one or multiple categories, full display window 409 is replaced by display box 405. Display box 405 may be displayed with the same or a renewed advertising category as shown in 400C. In one implementation, the user may select advertising categories displayed in full display window 409 with a priority ranking (not Shown in FIG. 4). As a result, the advertising category favored by the user may be displayed in display box 405.

The user may enter a search query 408 in search box 402 and actuates search button 404 accordingly. Contents matched to the query are delivered with advertising messages through personal device 102, wherein the advertising messages are selected based on selected advertising category.

In a slightly different implementation, display box 405 may be displayed as blanket box. The user selectable advertising categories may be displayed only after the user's actuation of selection button 407.

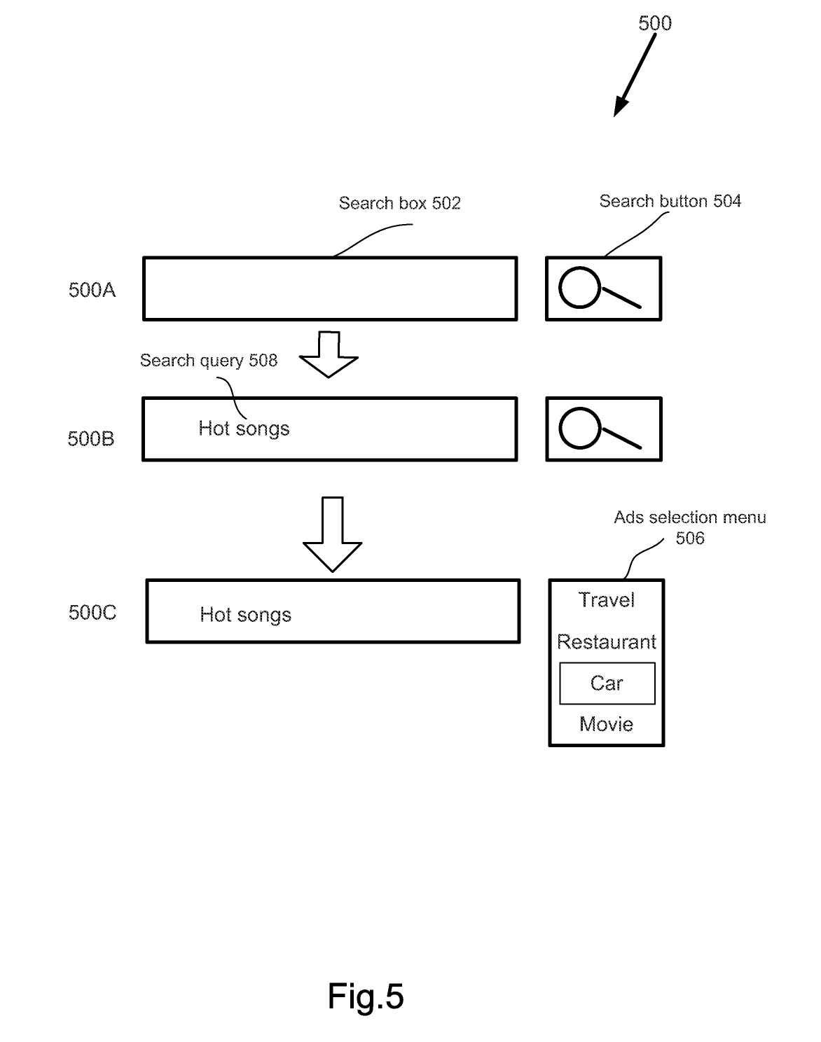

FIG. 5 is a schematic diagram illustrating an exemplary graphical user interface 500 in a third embodiment. In 500A, search box 502 and search button 540 are displayed in a similar manner to a conventional search engine interface. Subsequently, a search query 508 is entered into search box 502 by the user. Upon the user's actuation of search button 504 through a user input device, advertising selection menu 506 including a plurality of user selectable categories is displayed on the screen as shown in 500C. In one implementation, the displayed categories may be related to search query 508. In another implementation, the displayed categories may not be related to search query 508. Advertising selection menu 506 may be rendered according to a predetermined frequency. The predetermined frequency includes such as, for example, every time when the user enters a search query. However, because the user's interests in categories of commercial items may not change frequently, it is not necessary to ask for the user's selection every time the user enters a search query. The predetermined frequency includes but is not limited to once a year, once a month, once a week or once after very one thousand searches. The user may also be opted to be exempted from being asked the selections.

Upon the user's selection, search engine 106 displays exemplarily search results in a new page. The user may select one of the listed search results through the use of the user input device of personal device 102. Content provider 108 renders contents together with selected advertisements that are selected based on selected advertising categories. Search engine 106 and content provider 108 may be different entities. Search engine 106 and content provider 108 may be the same entity.

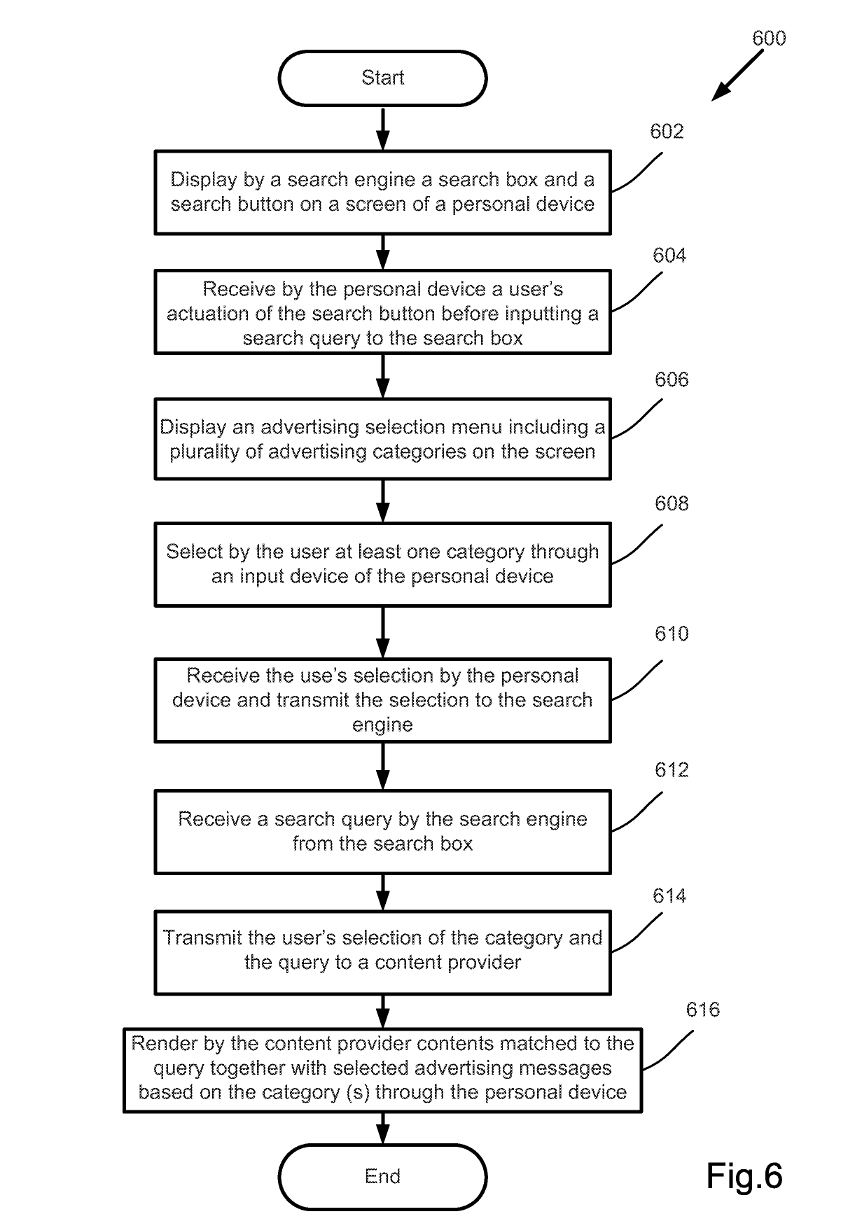

FIG. 6 is an exemplary flowchart illustrating operations of the graphical user interface according to the first embodiment of user interface (300). Process 600 starts with step 602 that a search box 302 and a search button 304 are displayed on a screen of personal device 102. The user actuates search button 304 while search box 302 is being blanket in step 604. The user's actuation is received by personal device 102 and is transmitted to search engine 106 in network 104. In step 606, advertising selection menu 306 including a plurality of user selectable advertising categories is displayed on the screen. In one implementation, advertising selection menu 306 may replace search button 304 with a larger display window. The categories are selected by advertising manager 106A before the advertising selection menu is displayed. The categories may be selected based additionally on the user's personal profile and/or the location of personal device 102. The user selects one or multiple categories through the use of a user input device of personal device 102 in step 608. In an exemplary case, the user touches and selects the categories using his or her fingers when the screen of personal device 102 is a touch-sensitive type display. In another exemplary case, the user selects the categories using a mouse, keyboard or a touchpad.

The user's selection is received by personal device 102 and is transmitted to search engine 106 in step 610. Subsequently, search box 304 is re-displayed to replace advertising selection menu 306. Personal device 102 receives a search query 308 entered by the user in search box 302 in step 614. Search query 308 is transmitted from personal device 102 to search engine 106 in step 614. Search engine 106 displays exemplarily a plurality of search results in a new page. The user selects one of the search results. Search engine 106 receives the selection and transmits the selection and previously selected advertising categories to content provider 108. In step 616, content provider 108 renders the contents matched to the user's search query together with advertising messages selected by advertising manager 108A.

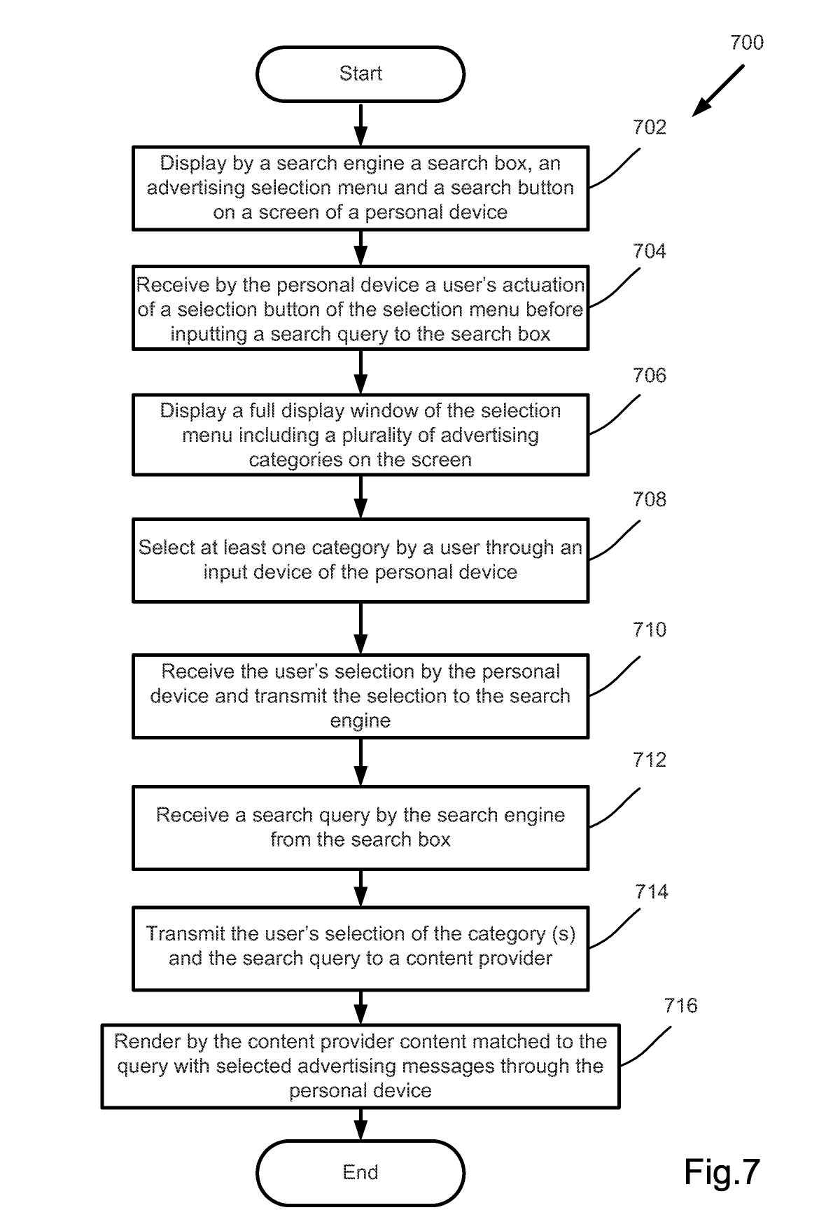

FIG. 7 is an exemplary flowchart illustrating operation of the graphical user interface according to the second embodiment of user interface (400). Process 700 starts with step 702 that a search box 402, an advertising selection menu 406 and a search button 404 are displayed on a screen of personal device 102. Advertising selection menu 406 further includes a display box 405 and a selection button 407. Display box 405 may display one advertising category. The category may be selected by search engine 106 as the most favorable category by the user based on the user's personal profile. The user actuates selection button 407 before a search query is entered into search box 402. The user's actuation is received by personal device 102 in step 704. In step 706, advertising selection menu 406 including a plurality of user selectable advertising categories is displayed on the screen. The categories are selected by advertising manager 106A of search engine 106 before the advertising selection menu is displayed. The categories may be selected based additionally on the user's personal profile and/or the location of the personal device. The user selects one or multiple categories through the use of a user input device of personal device 102 in step 708. In an exemplary case, the user touches and selects the categories using his or her fingers when the screen of personal device 102 is a touch-sensitive type display. In another exemplary case, the user selects the categories using a mouse, a keyboard or a touchpad. The user's selection is received by personal device 102 and is transmitted to search engine 106 in step 710. Subsequently, display box 405 is re-displayed to replace advertising selection menu 406.

Personal device 102 receives a search query 408 from the user in search box 302 in step 712. Search query 408 is transmitted from personal device 102 to search engine 106. Search engine 106 displays exemplarily a plurality of search results in a new page. The user selects one of the search results. Search engine 106 receives the selection and transmits the selected search result and previously selected categories to content provider 108 in step 714. In step 716, content provider 108 renders the contents matched to the user's search query together with advertising messages selected by advertising manager 108A.

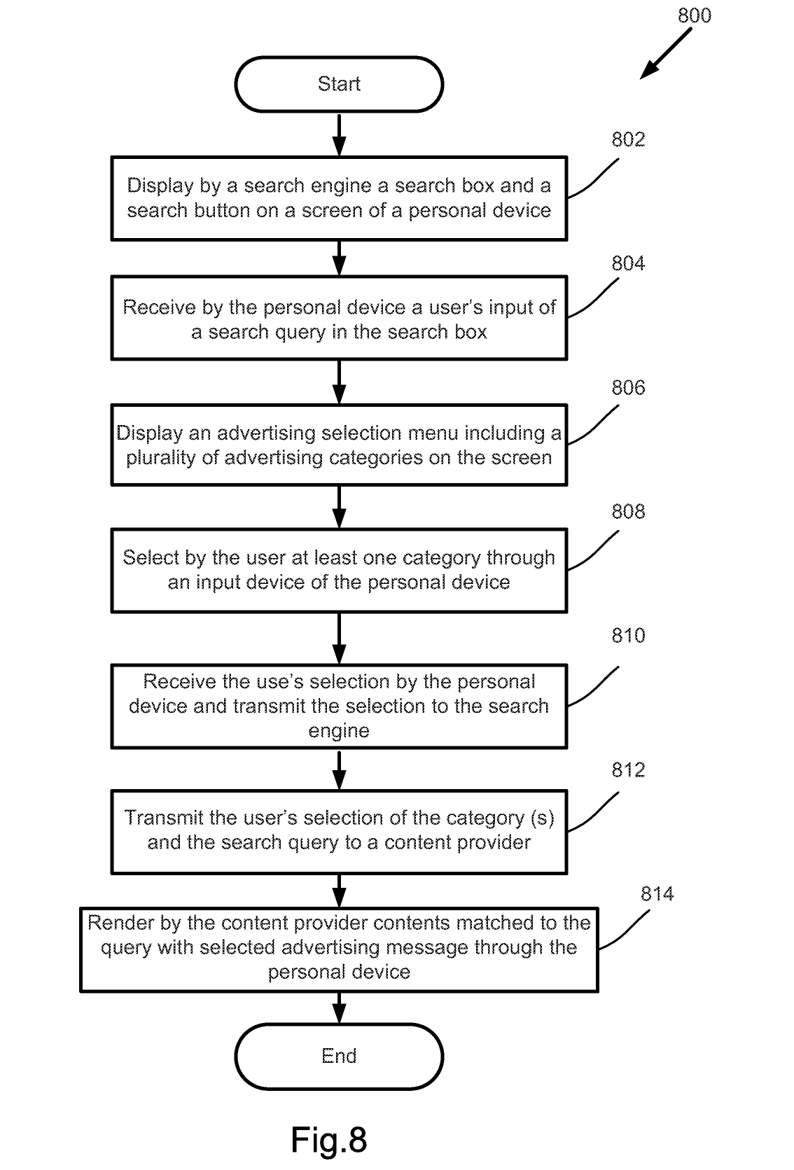

FIG. 8 is an exemplary flowchart illustrating operation of the user interface according to the third embodiment of user interface (500). Process 800 starts with step 802 that a search box 502 and a search button 504 are displayed on a screen of personal device 102. In step 804, a search query 508 entered by the user is received by personal device 102. Advertising selection menu 506 including a plurality of user selectable advertising categories is displayed in step 806. The categories may be selected by search engine 106. The categories may be related to search query 508. In the third embodiment, advertising menu 506 may be displayed according to a predetermined frequency, i.e., every month. The user selects one or multiple categories through a user input device of personal device 102 in step 808. The selected category is transmitted from personal device 102 to search engine 106 in step 810. Search engine 106 transmits the selection of the advertising categories together with search query 508 to content provider 108 in step 812. In step 814, content provider 108 renders the contents matched to the user's search query together with advertising messages selected by advertising manager 108A based on selected advertising categories.

FIGS. 6-8 illustrate three embodiment of the graphical user interface based on the first system embodiment as illustrated in FIG. 1. The flowcharts can be readily extended to the second system embodiment as illustrated in FIG. 2 as obvious to one skillful in the art. All such variations fall into scope of the present inventive concept as disclosed.

1. A user interface, comprising:
a. a search box displayed on a screen of a personal computing device by a search engine connected to the personal device through a communication network, said search box pertaining to receiving a user's query;
b. a search button displayed by said search engine in an adjacent position to the search box on the screen; and
c. an advertising selection window displayed on the screen after the user actuates said search button when said search box is blanket, said advertising selection window further including a plurality of user selectable advertising categories.

2. The user interface as recited in claim 1, wherein said advertising categories further comprising subcategories, said categories and subcategories are organized and are rendered in a hierarchical manner

3. The user interface as recited in claim 1, wherein said search button is displayed in right side or at bottom of the search box.

4. The user interface as recited in claim 1, wherein said advertising selection window is displayed with a larger window size than the search button, said search button is removed from the screen while said window is being displayed.

5. The user interface as recited in claim 4, wherein said search button is re-displayed to replace the advertising selection window after the user selects at least one of the advertising categories.

6. The user interface as recited in claim 1, wherein said personal device transmits the user's selection of at least one of the advertising categories to said search engine.

7. The user interface as recited in claim 6, wherein the user's selection is further transmitted to a content provider from the search engine after the query is received by the search engine.

8. The user interface as recited in claim 7, wherein said content provider renders contents matched to the query together with advertisements, said advertisements are selected based upon the user's selection of the advertising categories.

9. A user interface, comprising:
a. a search box displayed on a screen of a personal computing device by a search engine connected to the personal device through a communication network, said search box pertaining to receiving a user's query;
b. a search button displayed by said search engine in an adjacent position to the search box on the screen; and
c. an advertising selection window displayed on the screen, said window further including a plurality of user selectable advertising categories after a query is entered into the search box by the user.

10. The user interface as recited in claim 9, wherein said advertising selection window is displayed according to a predetermined frequency.

11. The user interface as recited in claim 9, wherein said predetermined frequency including once in a predetermined period of time or one in an accumulated search events.

12. The user interface as recited in claim 9, wherein said user selectable categories are related to the query.

13. The user interface as recited in claim 9, wherein said user selected categories are transmitted to the search engine through the communication network.

14. The user interface as recited in claim 13, wherein the selected categories are further transmitted to a content provider.

15. The user interface as recited in claim 14, wherein said content provider renders contents matched to the query together with advertisements through the use of the personal device, said advertisements are selected based upon selected categories.

16. A method of rendering an advertisement to a user of a personal computing device, comprising:
a. displaying a search box and a search button by a search engine on a display screen of the personal device, said personal device is connected to the search engine through a communication network;
b. receiving a user's actuation of the search button while the search box is blanket;
c. displaying an advertising selection menu with a plurality of user selectable advertisement categories;
d. selecting at least one of said categories by the user through a user input device of the personal device;
e. receiving a user's query entered into the search box by the search engine;
f. selecting by a content provider advertisements based upon selected categories; and
g. rendering the contents together with the advertisements through the use of the personal device.

17. The method as recited in claim 16, wherein said method further comprising transmitting selected advertising categories from the personal device to the search engine.

18. The method as recited in claim 16, wherein said method further comprising transmitting selected advertising categories from the search engine to the content provider.

19. The method as recited in claim 16, wherein said method further comprising sharing revenue generated from rendering the advertisements between the search engine and the content provider.

20. The method as recited in claim 16, wherein said contents comprising a video program, wherein said video program is rendered including the selected advertisements by the content provider.
